(19) United States
(12) Patent Application Publication
(10) Pub. No.: US 2011/0315280 A1
(43) Pub. Date: Dec. 29, 2011

(54) Method and Device for Annealing and Descaling Strips of Stainless Steel

(75) Inventors: Holger Behrens, Erkrath (DE); Klaus Frommann, Dusseldorf (DE); Hans-Georg Hartung, Pulheim (DE); Matthias Kretschmer, Koeln (DE); Lutz Kümmel, Juechen (DE)

(73) Assignee: SMS SIEMAG AG

(21) Appl. No.: 13/145,749

(22) PCT Filed: Dec. 12, 2009
(86) PCT No.: PCT/DE2009/001832

§ 371 Date: Sep. 12, 2011

(30) Foreign Application Priority Data
Jan. 22, 2009 (DE) 10 2009 005 797.8
Apr. 15, 2009 (DE) 10 2009 017 701.9

(51) Int. Cl. C21D 8/02; B08B 7/00; C21D 9/573

(52) U.S. Cl. 148/565; 266/103

(57) ABSTRACT

A method of annealing and descaling hot-rolled austenitic stainless steel strip wherein. The steel strip is descaled in a connected plasma descaling installation after annealing and subsequent cooling. The plasma descaling is carried out under vacuum in a plurality of stages, and the steel strip is subjected to a controlled cooling between these stages and after the final stage by means of cooling rolls so that the steel strip has a temperature below 100° C. when exiting the plasma descaling installation. An apparatus to practice the method is also disclosed.

### PRIORITY CLAIM

This is a U.S. national stage of application No. PCT/DE2009/001832, filed on Dec. 22, 2009. Priority is claimed on the following applications: Country: Germany, Application No.: 10 2009 005 797.8, Filed: Jan. 22, 2009; Country: Germany, Application No.: 10 2009 017 701.9, Filed: Apr. 15, 2009, the content of which is/are incorporated here by reference.

### FIELD OF THE INVENTION

The present invention is directed to a method for annealing and descaling hot-rolled or cold-rolled stainless steel strip.

### BACKGROUND OF THE INVENTION

For further processing of hot-rolled stainless steel strip and cold-rolled stainless steel strip, e.g., by cold rolling in case of hot strip and for the production of final products in case of cold strip, the steel strip must be annealed and have a surface which is free from scale. Therefore, the scale which forms during hot rolling and annealing must be completely removed. With the exception of ferritic hot strip, the annealing and descaling of stainless steel strip is carried out in-line in combined annealing and pickling lines in known methods. The annealing of hot-rolled or cold-rolled austenitic stainless steel strip and cold-rolled ferritic stainless steel strip is carried out in a horizontal continuous furnace followed by a cooling zone for cooling the strip to temperatures below 100° C.

On the other hand, for metallurgical reasons, ferritic stainless steel strip is subjected to prolonged hood annealing batchwise outside the annealing and pickling line followed by air cooling of the batch. Descaling of this material is usually carried out in the above-mentioned combined annealing and pickling lines, in which case only descaling is required because of the hood-type annealing that has already been performed, or in special pickling lines without an annealing furnace.

Descaling of hot-rolled austenitic and ferritic stainless steel strip in particular is very laborious and requires a plurality of steps in the known methods. In this case, the strip is initially pre-descaled mechanically by blasting with steel grit and by brushing so that much of the scale is removed. Pickling is subsequently carried out electrolytically and then chemically by means of different acids at elevated temperatures so that any remaining scale is completely removed. With cold-rolled austenitic and ferritic stainless steel strip, mechanical pre-descaling is not required because of the substantially thinner scale layer; further, roughness is increased excessively in this way.

The methods in current use are very laborious because the scale layer is relatively thick in hot strip and the chromium-rich iron oxides have poor solubility and are therefore difficult to remove. Further, disposal of used acids, waste water and the toxic off-gases resulting from pickling is very costly.

As always, the descaling of stainless steel strip entails an environmental burden which is very costly to minimize.

Plasma technology is a new, environmentally friendly method for descaling stainless steel strip. References which may be cited by way of example and which are incorporated herein by reference in their entirety are EP 1 814 678 B1, WO 00/056949 A1, and RU 2 145 912 C1. In the plasma descaling technology disclosed therein, the steel strip to be descaled runs between special electrodes which are located in a vacuum chamber. Descaling is carried out by the plasma located between the electrodes and the steel strip, and the surface of the strip is metallically clean at the conclusion of the descaling process.

After plasma descaling, the steel strip is cooled under vacuum by cooling rolls to reduce the strip heat resulting from the plasma descaling to a maximum temperature of 100° C. before exiting from the vacuum chamber.

### SUMMARY OF THE INVENTION

It is an object of the invention to improve this plasma descaling for use with stainless steel strip.

This object is met according to the present invention by providing a method of annealing and descaling hot-rolled austenitic stainless steel strip comprising annealing the steel strip in a continuous line at a temperature of up to a maximum of 1200° C. in a continuous furnace, then cooling the strip to a temperature below 100° C. in a subsequent cooling section, then straightening the strip in a stretching-bending-straightening device; subsequently descaling the strip in a connected plasma descaling installation, wherein the plasma descaling is carried out under vacuum in a plurality of stages; and subjecting the steel strip to a controlled cooling between these stages and after the final stage by means of cooling rolls so that the steel strip has a temperature below 100° C. when exiting the plasma descaling installation. In a further embodiment the present invention provides a method of annealing and descaling hot-rolled ferritic stainless steel strip, comprising subjecting the steel strip batchwise to prolonged annealing in a hood-type annealing device; thereafter cooling the batch to a temperature below 100° C.; subsequently descaling the strip in a connected plasma descaling installation, wherein the plasma descaling is carried out under vacuum in a plurality of stages; and subjecting the steel strip to a controlled cooling between these stages and after the final stage by means of cooling rolls so that the steel strip has a temperature below 100° C. when exiting the plasma descaling installation. The above methods may additionally comprise the step of carrying out a mechanical pre-descaling prior to the plasma descaling by blasting with steel grit in a blasting device.

In yet a further embodiment the present invention provides a method of annealing and descaling cold-rolled austenitic and ferritic stainless steel strip, comprising descaling the cold-rolled steel strip after annealing and cooling in a continuous line in a connected plasma descaling installation taking into account the process parameters for the annealing and descaling with the specific requirements for cold-rolled strip, wherein the plasma descaling is carried out under vacuum in a plurality of stages; and subjecting the steel strip to a controlled cooling between these stages and after the final stage by means of cooling rolls so that the steel strip has a temperature below 100° C. when exiting the plasma descaling installation. The methods according to the present invention comprise the additional step of adapting the production output of the plasma descaling installation to the required strip speed in the annealing furnace and to the requirements of different scale layers of different materials by controlling the entire length of the active plasma descaling section by switching the plasma electrodes on and off. Preferably, the methods according to the present invention include one or more of the steps of stretching, straightening and dressing of the descaled steel strip continuously inline following the plasma descaling.

Finally, the present invention also includes an apparatus for carrying out the methods of the present invention, comprising arranging in a conveying direction (R) of the steel strip a continuous furnace followed by a cooling section, a device for stretching, bending and straightening, a device for mechanical pre-descaling by blasting with steel grit, and a plasma descaling installation with devices for strip cooling.

Plasma technology presents a descaling technology which is environmentally friendly, of impeccable quality, and economical particularly for stainless steel strip. The cooled hot-rolled or cold-rolled stainless steel strip can be completely descaled in a combined annealing and descaling line by plasma technology alone. In a variant for hot-rolled austenitic and ferritic stainless steel strip, pre-descaling by steel grit blasting is combined with subsequent plasma descaling so that the process time required for plasma descaling can be sharply reduced.

Mechanical pre-descaling is not considered for cold-rolled stainless steel strip because the scale layer is substantially thinner compared to hot-rolled strip.

### BRIEF DESCRIPTION OF THE DRAWINGS

The invention will be described in the following with reference to the drawing in which:

FIG. 1 is a schematic representation of a device for annealing and descaling stainless steel strip in accordance with the present invention.

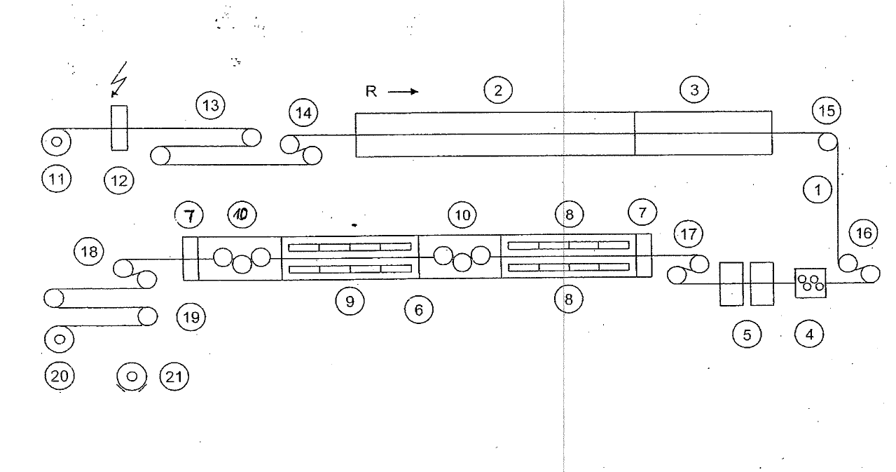

### DETAILED DESCRIPTION OF THE PRESENTLY PREFERRED EMBODIMENTS

The steel strip 1 is wound off from a pay-off reel 11. The ends of the successive strip coil are welded together by the welding machine 12. Subsequently, the strip runs through a strip storage 13 and then along a bridle 14 to generate strip tension, then through the horizontal annealing furnace 2 in which it is briefly annealed at temperatures of up to a maximum of 1200° C. After annealing, the steel strip 1 runs through the cooling zone 3 in which it is cooled by air or air and water spray mist to temperatures below 100° C. Thereupon, the steel strip 1 runs in the transport direction R around the deflector roller 15 and via the bridle 16 through the stretching-bending-straightening device 4 to produce a flat strip. The strip then runs through the steel grit blasting device 5, by means of which hot-rolled stainless steel strip 1 can be pre-descaled. The steel grit blasting device 5 is not required given a correspondingly higher-power plasma descaling installation 6.

The steel strip 1 then runs along another bridle 17, which is required for generating strip tension, through a multi-stage vacuum lock 7, into the process chamber 8 of the plasma descaling installation 6 in which the plasma descaling takes place. Electrodes 9 are arranged above and below the strip 1 over the entire width of the strip at a specified distance from the strip for generating the plasma. The plasma descaling installation 6 which is shown schematically in the drawing has two process chambers 8. The quantity and length of the process chambers 8 may vary depending upon the installation. A cooling zone having adjustable cooling rolls 10 which are likewise under vacuum is arranged between the process chambers for strip cooling. The steel strip is cooled by the cooling rolls 10 preferably to a temperature below 100° C. and then runs through the second process chamber 8 in which electrodes are also arranged above and below the steel strip 1 for generating the plasma. Any scale still present is completely removed from both sides of the steel strip in this process chamber. During the plasma descaling, the movement of cathode focal spot over the two surfaces of the strip is preferably controlled by moving electromagnetic fields. The descaled steel strip then runs through the second cooling zone having three cooling rolls 10 in which the strip is cooled to a temperature below 100° C. The strip then runs through the multi-stage vacuum lock 7 and then enters the air atmosphere.

The steel strip 1 runs along a bridle 18 and along a strip storage 19 to the coiler 20, where it is wound up to form the finished coil 21.

Overall, the method and installation described above for annealing and descaling stainless steel strip results in an economical and ecologically very advantageous technology for producing high-quality stainless steel strip which meets commercial requirements.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-8. (canceled)

9. A method of annealing and descaling hot-rolled austenitic stainless steel strip comprising:
annealing the steel strip in a continuous line at a temperature of up to a maximum of 1200° C. in a continuous furnace;
then cooling the strip to a temperature below 100° C. in a subsequent cooling section;
then straightening the strip in a stretching-bending-straightening device;
subsequently descaling the strip in a connected plasma descaling installation, wherein the plasma descaling is carried out under vacuum in a plurality of stages; and
subjecting the steel strip to a controlled cooling between these stages and after the final stage by means of cooling rolls so that the steel strip has a temperature below 100° C. when exiting the plasma descaling installation.

10. A method of annealing and descaling hot-rolled ferritic stainless steel strip, comprising:
subjecting the steel strip batchwise to prolonged annealing in a hood-type annealing device;
thereafter cooling the batch to a temperature below 100° C.;
subsequently descaling the strip in a connected plasma descaling installation, wherein the plasma descaling is carried out under vacuum in a plurality of stages; and
subjecting the steel strip to a controlled cooling between these stages and after the final stage by means of cooling rolls so that the steel strip has a temperature below 100° C. when exiting the plasma descaling installation.

11. The method according to claim 9, additionally comprising the step of carrying out a mechanical pre-descaling prior to the plasma descaling by blasting with steel grit in a blasting device.

12. The method according to claim 10, additionally comprising the step of carrying out a mechanical pre-descaling prior to the plasma descaling by blasting with steel grit in a blasting device.

13. A method of annealing and descaling cold-rolled austenitic and ferritic stainless steel strip, comprising:
descaling the cold-rolled steel strip after annealing and cooling in a continuous line in a connected plasma descaling installation taking into account the process parameters for the annealing and descaling with the specific requirements for cold-rolled strip, wherein the plasma descaling is carried out under vacuum in a plurality of stages; and
subjecting the steel strip to a controlled cooling between these stages and after the final stage by means of cooling rolls so that the steel strip has a temperature below 100° C. when exiting the plasma descaling installation.

14. The method according to claim 9, comprising the additional step of adapting the production output of the plasma descaling installation to the required strip speed in the annealing furnace and to the requirements of different scale layers of different materials by controlling the entire length of the active plasma descaling section by switching the plasma electrodes on and off.

15. The method according to claim 9, additionally comprising one or more of the steps of stretching, straightening and dressing of the descaled steel strip continuously inline following the plasma descaling.

16. The method according to claim 9, additionally comprising controlling the movement of the cathode focal spot over the two surfaces of the strip during the plasma descaling by moving electromagnetic fields.

17. An apparatus for carrying out the method according to claim 9, comprising the additional step of arranging, in a conveying direction (R) of the steel strip, a continuous furnace followed by a cooling section, a device for stretching, bending and straightening, a device for mechanical pre-descaling by blasting with steel grit, and a plasma descaling installation with devices for strip cooling.

18. The apparatus of claim 17, wherein the continuous furnace is a horizontal continuous furnace.

19. The method according to claim 11, comprising the additional step of adapting the production output of the plasma descaling installation to the required strip speed in the annealing furnace and to the requirements of different scale layers of different materials by controlling the entire length of the active plasma descaling section by switching the plasma electrodes on and off.

20. The method according to claim 12, comprising the additional step of adapting the production output of the plasma descaling installation to the required strip speed in the annealing furnace and to the requirements of different scale layers of different materials by controlling the entire length of the active plasma descaling section by switching the plasma electrodes on and off.

21. The method according to claim 14, comprising the additional step of adapting the production output of the plasma descaling installation to the required strip speed in the annealing furnace and to the requirements of different scale layers of different materials by controlling the entire length of the active plasma descaling section by switching the plasma electrodes on and off.

22. The method according to claim 15, comprising the additional step of adapting the production output of the plasma descaling installation to the required strip speed in the annealing furnace and to the requirements of different scale layers of different materials by controlling the entire length of the active plasma descaling section by switching the plasma electrodes on and off.

23. The method according to claim 11, additionally comprising one or more of the steps of stretching, straightening and dressing of the descaled steel strip continuously inline following the plasma descaling.

24. The method according to claim 14, additionally comprising one or more of the steps of stretching, straightening and dressing of the descaled steel strip continuously inline following the plasma descaling.

25. The method according to claim 15, additionally comprising one or more of the steps of stretching, straightening and dressing of the descaled steel strip continuously inline following the plasma descaling.

26. An apparatus for carrying out the method according to claim 11, comprising in a conveying direction (R) of the steel strip a continuous furnace followed by a cooling section, a device for stretching, bending and straightening, a device for mechanical pre-descaling by blasting with steel grit, and a plasma descaling installation with devices for strip cooling.

27. An apparatus for carrying out the method according to claim 14, comprising in a conveying direction (R) of the steel strip a continuous furnace followed by a cooling section, a device for stretching, bending and straightening, a device for mechanical pre-descaling by blasting with steel grit, and a plasma descaling installation with devices for strip cooling.

28. An apparatus for carrying out the method according to claim 15, comprising in a conveying direction (R) of the steel strip a continuous furnace followed by a cooling section, a device for stretching, bending and straightening, a device for mechanical pre-descaling by blasting with steel grit, and a plasma descaling installation with devices for strip cooling.
